(19) United States
(12) Patent Application Publication
(10) Pub. No.: US 2007/0201468 A1
(43) Pub. Date: Aug. 30, 2007

(54) Multicast group address signaling using MAC header for power save delivery in a wireless network

(76) Inventor: Jari Jokela, Ylojarvi (FI)

Correspondence Address: BRAKE HUGHES BELLERMANN LLP, c/o INTELLEVATE, P.O. BOX 52050, MINNEAPOLIS, MN, 55402, US

(21) Appl. No.: 11/711,542

(22) Filed: Feb. 27, 2007

Related U.S. Application Data
(60) Provisional application No. 60/777,336, filed on Feb. 28, 2006.

(51) Int. Cl. H04L 12/56; H04L 12/28

(52) U.S. Cl. 370/390; 370/395.4

(57) ABSTRACT

Various embodiments are disclosed relating to multicast group address signaling using a MAC header for power save delivery in a wireless network. According to an example embodiment, a multicast management frame (e.g., a multicast 802.11n Power Save Multi Poll (PSMP) frame) may be transmitted to identify a scheduled multicast data transmission to one or more receiver nodes in a wireless network. The multicast management frame may include a multicast group address provided in a Medium Access Control (MAC) destination address field of a MAC header of the management frame. The management frame may also include one or more downlink transmission fields to identify a time and/or duration of the scheduled multicast data transmission.

This application claims priority based on U.S. Provisional Application No. 60/777,336, filed on Feb. 28, 2006, entitled, “MULTICAST GROUP ADDRESS SIGNALING USING MAC HEADER FOR POWER SAVE DELIVERY IN A WIRELESS NETWORK,” the disclosure of which is hereby incorporated by reference.

### BACKGROUND

The diffusion of Wireless Local Area Network (WLAN) access and the increasing demand for WLAN coverage is driving the installation of a large number of Access Points (AP). The most common WLAN technology is described in the Institute of Electrical and Electronics Engineers IEEE 802.11 family of industry specifications, such as specifications for IEEE 802.11b, IEEE 802.11g and IEEE 802.11a. A number of different 802.11 task groups are involved in developing specifications relating to improvements to the existing 802.11 technology. The IEEE 802.11n task group has developed a High Throughput (HT) draft specification, entitled “Wireless LAN Medium Access Control (MAC) and Physical Layer (PHY) specifications: Enhancements for Higher Throughput,” IEEE 802.11n.D0.01, January 2006.

The 802.11n HT draft specification has proposed the use of a Power Save Multi Poll (PSMP) management frame, which is a MAC control frame that may be used by an AP to provide a data transmission schedule (e.g., time and duration for uplink and/or downlink transmissions) to one or more PSMP receiver nodes. However, the 802.11n PSMP frame provides inadequate support for multicast data transmissions.

### SUMMARY

Various embodiments are disclosed relating to multicast group address signaling using a MAC header for power save delivery in a wireless network.

According to an example embodiment, a multicast management frame (e.g., a multicast 802.11n Power Save Multi Poll (PSMP) frame) may be transmitted to identify a scheduled multicast data transmission to one or more receiver nodes in a wireless network, the multicast management frame including a multicast group address provided in a Medium Access Control (MAC) destination address field of a MAC header of the management frame, the management frame including one or more downlink transmission fields to identify a time and/or duration of the scheduled multicast data transmission.

According to another example embodiment, a multicast management frame may be transmitted (e.g., by an AP, Base Station or other node) to identify a scheduled multicast downlink data transmission to one or more receiver nodes in a wireless network. In an example embodiment, the management frame (e.g., PSMP frame) may include: a multicast group address provided in a Medium Access Control (MAC) destination address field of a MAC header of the management frame; a field indicating multicast transmission; a field indicating a transmission start time for the multicast transmission; and a field indicating a transmission duration of the multicast transmission.

According to another example embodiment, a management frame may be transmitted to one or more receiver nodes in a wireless network. The management frame (e.g., PSMP frame) may include a data transmission schedule. One or more multicast downlink data transmissions may be transmitted after the transmitting the management frame, the multicast downlink data transmissions being transmitted at times indicated by the management frame. After transmitting the multicast data transmissions, one or more downlink unicast data transmissions may be transmitted to one or more of the receiver nodes at times indicated by the management frame. After transmitting the downlink unicast data transmissions, uplink unicast transmissions may be received, if any, from one or more of the receiver nodes.

According to another example embodiment, a multicast management frame may be transmitted to identify a scheduled multicast data transmission to one or more receiver nodes in a wireless network. The multicast management frame may include a multicast group address provided in a MAC destination address field of a MAC header of the management frame. The management frame may include the following for each receiver node: fields to identify the multicast transmissions, a station identifier to identify the receiver node, and an uplink transmission schedule to identify a time for the receiver node to transmit data frames and/or transmit acknowledgments to acknowledge receipt of one or more data frames of the scheduled multicast data transmission.

According to another example embodiment, a multicast management frame may be transmitted to one or more receiver nodes in a wireless network to identify a scheduled unicast data transmission. The multicast management frame may include a multicast group address provided in a MAC destination address field of a MAC header of the management frame. The management frame may include the following for each receiver node: fields to identify the multicast transmissions; a station identifier to identify the receiver node; a downlink transmission schedule to identify a time for the receiver node to receive a unicast downlink data transmission; and an uplink transmission schedule to identify a time for the receiver node to transmit data frames, acknowledgments and/or other frames.

According to another example embodiment, an apparatus may be provided in a wireless node of a wireless network. The apparatus may include a controller, a memory coupled to the controller, and a wireless transceiver coupled to the controller. The apparatus may be adapted to transmit a multicast management frame to identify a scheduled multicast data transmission to one or more receiver nodes in a wireless network. The multicast management frame may include a multicast group address provided in a MAC destination address field of a MAC header of the management frame and one or more downlink transmission fields to identify a time and/or duration of the scheduled multicast data transmission.

According to another example embodiment, an apparatus may be provided in a wireless node of a wireless network. The apparatus may be adapted to transmit a multicast management frame to identify a scheduled multicast data transmission to one or more receiver nodes in a wireless network. The multicast management frame may include a multicast group address provided in a MAC destination address field of a MAC header of the management frame. The multicast management frame may further include the following for each receiver node: fields to identify the multicast transmissions, a station identifier to identify the receiver node, and an uplink transmission schedule to identify a time for the receiver node to transmit data frames and/or transmit acknowledgements to acknowledge receipt of one or more data frames of the scheduled multicast data transmission.

According to another example embodiment, an article may comprise a storage medium. The storage medium may include instructions stored thereon that, when executed by a processor, result in transmitting a multicast management frame to one or more receiver nodes in a wireless network to identify a scheduled unicast data transmission. The multicast management frame may include a multicast group address provided in a MAC destination address field of a MAC header of the management frame. The multicast management frame may include the following for each receiver node: fields to identify the multicast transmissions; a station identifier to identify the receiver node; a downlink transmission schedule to identify a time for the receiver node to receive a unicast downlink data transmission; and an uplink transmission schedule to identify a time for the receiver node to transmit data frames, acknowledgements and/or other data frames.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating a wireless network according to an example embodiment.

FIG. 2 is a diagram illustrating a format of a multi poll message, such as a Power Save Multi Poll (PSMP) management frame, according to an example embodiment.

FIG. 3 is a diagram illustrating a PSMP sequence according to an example embodiment.

FIG. 4 is a diagram illustrating a PSMP sequence according to another example embodiment.

FIG. 5 is a diagram illustrating a PSMP sequence according to yet another example embodiment.

FIG. 6 is a flow chart illustrating operation of a wireless node according to an example embodiment.

FIG. 7 is a flow chart illustrating operation of a wireless node according to another example embodiment.

FIG. 8 is a flow chart illustrating operation of a wireless node according to yet another example embodiment.

FIG. 9 is a block diagram illustrating an apparatus 900 that may be provided in a wireless node according to an example embodiment.

FIG. 10 is a flow chart illustrating operation of a wireless node according to another example embodiment.

FIG. 11 is a flow chart illustrating operation of a wireless node according to yet another example embodiment.

### DETAILED DESCRIPTION

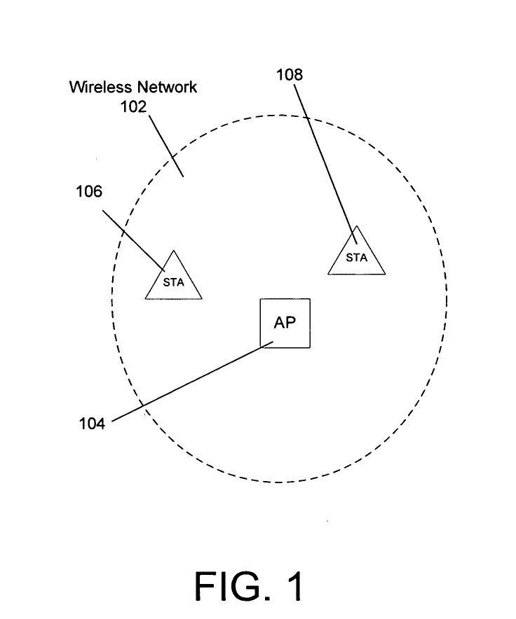

Referring to the Figures in which like numerals indicate like elements, FIG. 1 is a block diagram illustrating a wireless network according to an example embodiment. Wireless network 102 may include a number of wireless nodes or stations, such as an access point (AP) 104 or base station and one or more mobile stations, such as stations 106 and 108. While only one AP 104 and two mobile stations 106, 108 are shown in wireless network 102, any number of APs and stations may be provided. Each station in wireless network 102 (e.g., stations 106, 108) may be in wireless communication with the AP 104, and may even be in direct communication with each other. Although not shown, AP 104 may be coupled to a fixed network, such as a Local Area Network (LAN), Wide Area Network (WAN), the Internet, etc., and may also be coupled to other wireless networks.

The various embodiments described herein may be applicable to a wide variety of networks and technologies, such as WLAN networks (e.g., IEEE 802.11 type networks), IEEE 802.16 WiMAX networks, cellular networks, radio networks, or other wireless networks. In another example embodiment, the various examples and embodiments may be applied, for example, to a mesh wireless network, where a plurality of mesh points (e.g., Access Points) may be coupled together via wired or wireless links. The various embodiments described herein may be applied to wireless networks, both in an infrastructure mode where an AP or base station may communicate with a station (e.g., communication occurs through APs), as well as an ad-hoc mode in which wireless stations may communicate directly via a peer-to-peer network, for example.

The term “wireless node” or “node,” or the like, may include, for example, a wireless station, an access point (AP) or base station, a wireless personal digital assistant (PDA), a cell phone, an 802.11 WLAN phone, a wireless mesh point, or any other wireless device. These are merely a few examples of the wireless devices that may be used to implement the various embodiments described herein, and this disclosure is not limited thereto.

In an example embodiment, mobile multimedia/TV or video applications may allow multiple stations 106, 108 or nodes to be grouped together to receive a common channel they are watching, e.g., by associating this group of stations 106, 108 watching the channel with a multicast group address. This may allow each of the stations 106, 108 or wireless nodes to receive this TV program or video information via multicast transmission, for example. This is merely one example application, and the various techniques and embodiments described herein may be applied to a wide variety of applications.

In an example embodiment, a wireless node (e.g., AP 104 or station 106) may determine capabilities of other nodes by receiving a capabilities field (e.g., indicating whether the node is Power Save Multi Poll (PSMP) capable or not) in a beacon message or probe response (e.g., from an AP 104) and via an association request or re-association request (e.g., from a station 106), for example. An AP 104 may associate with one or more wireless stations 106, 108 or nodes. The PSMP capable stations 106, 108 may be referred to as PSMP receivers (to receive a PSMP frame) or PSMP receiver nodes, while the AP 104 may be referred to as a PSMP transmitter.

After a station 106 is associated with an AP 104, the two nodes 106, 104 may establish a data transmission schedule, indicating a service period, by exchanging one or more frames or messages indicating a schedule start time for the service period. A variety of different mechanisms may be used to exchange or agree on a time for a service period.

For example, the IEEE 802.11e draft specification allows for power management through automatic power-save delivery (APSD). APSD provides two delivery mechanisms: scheduled APSD and unscheduled APSD. Stations 106, 108 may use unscheduled APSD (U-APSD) to have all or some of their frames delivered to them from the AP 104 during unscheduled service periods. An unscheduled service period may begin when the AP 104 receives a trigger message from the station 106. According to scheduled APSD (S-APSD), a station 106 may receive a data transmission schedule from an AP 104 indicating a service start time and service interval when the station 106 may receive and transmit frames during scheduled service periods. For example, by using APSD, a station may conserve power and extend battery life by remaining in a lower power state, and then waking during a scheduled or unscheduled service period to receive and transmit data. In case of broadcast or multicast transmissions from an Access Point (AP) or Base Station (BS) or other node, in which data is to be transmitted to stations 106, 108 of which one or more stations 106, 108 may be in power save mode, the transmissions may take place right after a Beacon frame containing DTIM (Delivery Traffic Indication Message) is sent. So in this case, the DTIM interval may determine the broadcast/multicast service period.

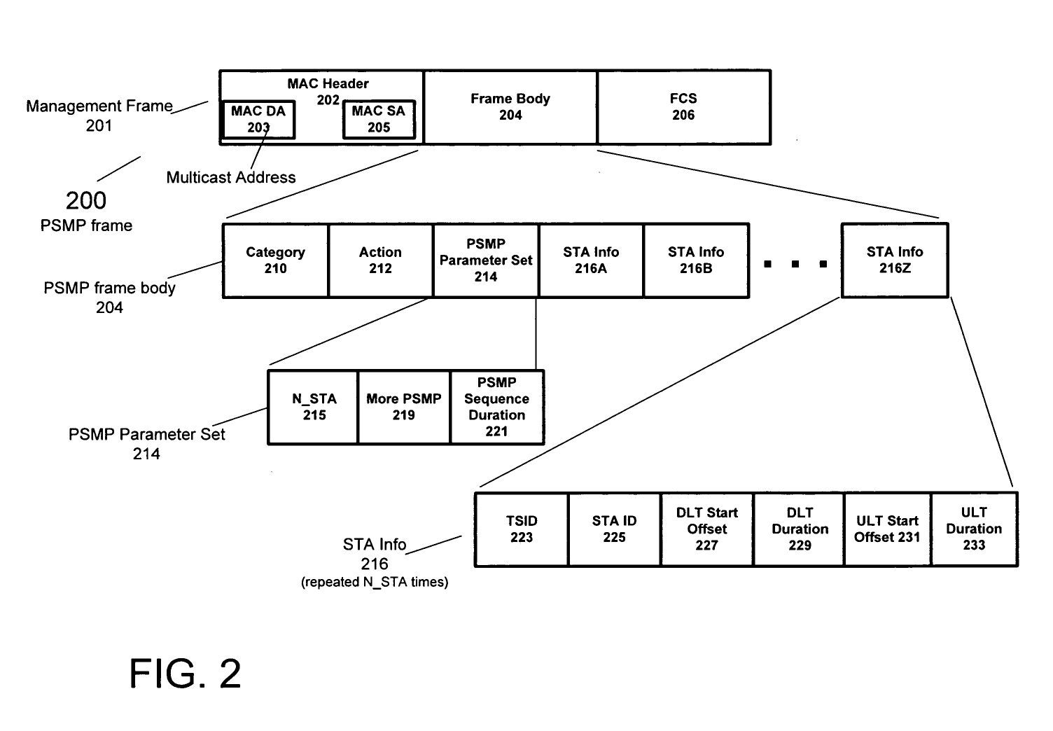

In an example embodiment, an AP 104 may allocate the same service period for multiple stations or nodes 106, 108, which may require each of these multiple stations 106, 108 to be awake during a substantial portion of (or even all of) the service period in some cases, as examples. The PSMP frame (discussed below with reference to FIG. 2) may allow an AP 104 to provide sub-schedules to each of a plurality of stations 106, 108. These PSMP data transmission schedules, or sub-schedules, may indicate for example a downlink start time and duration (for a scheduled transmission from the AP 104 to a specified station 106), and/or an uplink start time and duration (for a scheduled transmission time where a specified station 106 may be permitted to transmit data to the AP 104).

FIG. 2 is a diagram illustrating a format of a multi poll message, such as an IEEE 802.11n Power Save Multi Poll (PSMP) management frame 200, according to an example embodiment. A management frame 201 may include a MAC header 202 that may include MAC destination address (DA) 203, a MAC source address (SA) 205, and other fields. According to an example embodiment, a multicast group address may be provided in the MAC destination address field 203, as described in greater detail below. The management frame 201 may also include a frame body 204 and a frame check sequence (FCS) 206, for example.

In an example embodiment, the frame body 204 may be a Power Save Multi Poll (PSMP) frame body. The frame body 204 may include a category field 210 set to a value indicating High Throughput (HT) (e.g., HT related frame), for example. Frame body 204 may also include an Action field 212 set to a value indicating a PSMP frame 200.

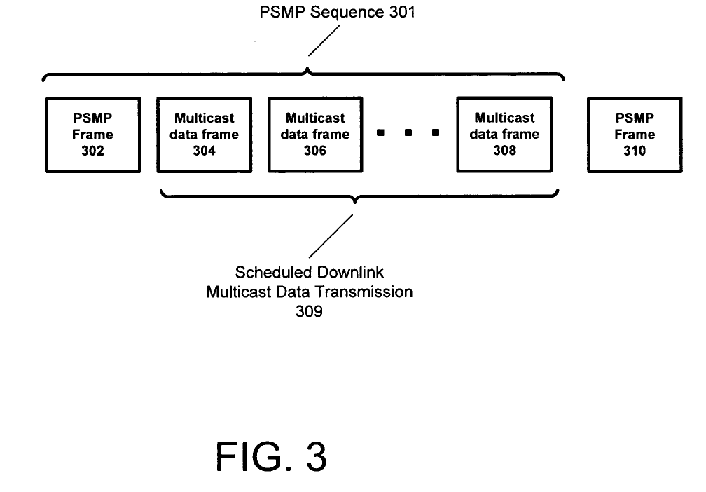

Frame body 204 may also include a PSMP parameter set 214 and one or more station information fields (STA Info fields) 216. PSMP parameter set 214 may include a number of stations (N_STA) field 215 indicating a number of station information fields (STA Info fields) 216 present in the frame body 204. A More PSMP field 219 of the PSMP parameter set 214 may be set to a 1, for example, to indicate that this PSMP sequence will be followed by another PSMP sequence, and set to 0 to indicate that this is the last PSMP sequence during this service period. A PSMP sequence (discussed further with reference to FIG. 3) may include, for example, a PSMP frame 200 followed by a scheduled data transmission to (downlink) and/or from (uplink) one or more stations 106, 108, as indicated by the PSMP frame 200. PSMP sequence duration field 221 indicates the duration of the current PSMP sequence which is described by the PSMP frame 200.

As noted above, an AP 104 may transmit to a plurality of stations 106, 108 and/or receive from a plurality of stations 106, 108, according to the information provided in the one or more station information (STA Info) fields 216. A STA Info field 216 may be provided, for example, for each station 106 for which uplink and/or downlink transmission is being scheduled by the PSMP message (for the current PSMP sequence). The number of STA Info fields 216 may be indicated by the N_STA field 215. Therefore, the PSMP frame body 204 illustrated in FIG. 2 may include one or more STA Info fields 216, such as STA Info fields 216A, 216B, . . . 216Z, as an example.

Each STA Info field 216 may include a plurality of fields. The STA Info field 216 may include a traffic stream identifier (TSID) field 223, which may identify one or more TSIDs that a station 106 may or should use for transmitting data back to the AP 104 for a scheduled uplink data transmission, for example. A station identifier (STA ID) field 225 may identify the station 106 (e.g., using either a portion of a MAC address of the station 106 or the Association ID for the station 106). Although not required, in an example embodiment, the STA ID field 225 in STA Info field 216 may be set to 0 to indicate a multicast transmission. In addition, STA ID field 225 may also be set to all 1's to indicate a broadcast transmission. The TSID field 223 and the STA ID field 225 may not necessarily be applicable for the scheduling of a multicast transmission (e.g., upstream TSIDs not applicable for downstream multicast transmission, and a multicast frame is typically directed to multiple receiver nodes 106, 108 and thus one STA ID field 225 would typically be inadequate, for example).

The downlink transmission (DLT) start offset field 227 may indicate a start time for the scheduled downlink data transmission (from AP 104 to station 106), and a downlink transmission (DLT) duration field 229 may indicate a duration for the scheduled downlink transmission. These two DLT related fields (227, 229) may be applicable for both a unicast transmission (e.g., transmission to a single receiver node 106) and a multicast transmission (multicast may be, for example, a downlink data transmission from the AP 104 to multiple receiver nodes or stations 106, 108).

An uplink transmission (ULT) (from station 106 to AP 104) start offset field 231 and a ULT duration field 233 may be provided within the STA Info field 216 to communicate a start time and duration for a scheduled uplink data transmission.

FIG. 3 is a diagram illustrating a PSMP sequence 301 according to an example embodiment. A PSMP sequence 301 may include a PSMP frame 302 transmitted by an AP 104 to one or more receiver nodes 106, 108, and a scheduled downlink multicast data transmission 309, for example. PSMP frame 302 may be transmitted, setting the MAC destination address field 203 to a multicast group address. By providing the multicast group address within the full-size MAC destination address field 203, the full-size multicast group address may be transmitted, e.g., without compressing or converting the multicast group address to a smaller size. The PSMP frame 302 may be transmitted, setting the TSID field 223=0 (or don't care), and/or setting STA ID field 225=0 (or don't care), since these fields may not be applicable to a multicast data transmission, as noted above. Note that it may not be necessary for the STA ID to identify receiver nodes 106, 108 to receive the multicast data transmission and associated schedule, since this group of receiver nodes 106, 108 (members of the multicast group) may be identified by the multicast group address provided in the MAC destination address 203.

The DLT fields 227 and 229 may be set to values to indicate the start time and duration, respectively, for the multicast data transmission 309 (which is a downlink transmission in this example). In addition, in the PSMP frame 302, the ULT fields 231 and 233 may be set to 0, for example, since in this example only downlink data transmissions have been scheduled.

After transmitting the PSMP frame 302, the AP 104 may then transmit the one or more multicast data frames (frames 306, 308, etc.) to one or more receiver nodes 106, 108. The multicast group address used in the MAC destination address field 203 of the multicast data frames 306, 308 may typically be the same as the multicast group address provided in the MAC destination address field 203 of the PSMP frame 302, for example. Thus, the multicast data frames 304, 306, 308 following the multicast PSMP frame 302 may all be transmitted to the same group of one or more receiver nodes 106, 108, for example. Therefore, in this example, the PSMP frame 302 may be transmitted by an AP 104 as a multicast frame to communicate a multicast transmission schedule to one or more receiver nodes 106, 108 that are members of the multicast group identified by the multicast group address. A PSMP frame 310 may start the next PSMP sequence 301, for example.

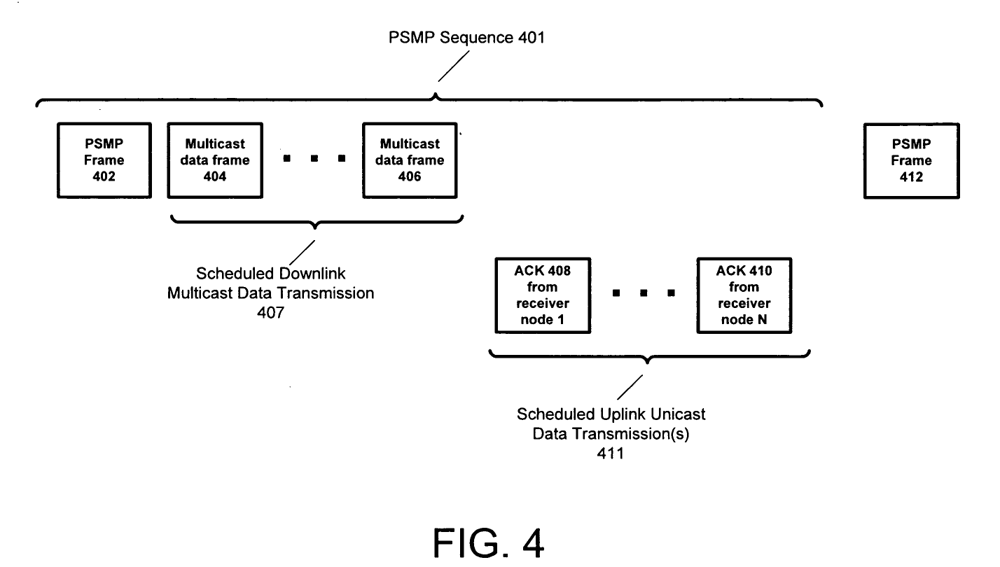

FIG. 4 is a diagram illustrating a PSMP sequence 401 according to another example embodiment. In the example embodiment shown in FIG. 4, a PSMP sequence 401 may include the transmission of a PSMP frame 402, followed by the transmission of a scheduled downlink multicast data transmission 407 to one or more receiver nodes 106, 108, and the transmission of a scheduled uplink unicast transmission 411 from one or more receiver nodes 106, 108. The PSMP frame 402, and subsequent scheduled multicast data frames 406, 408 may include a MAC destination address field 203 set to a multicast group address. In this example embodiment, within PSMP frame 402, the TSID field 223 may be set to 0 or other value, and STA ID field 225 may be set to an AID (e.g., Association ID) of the receiver node 106. The DLT fields 227 and 229 of the PSMP frame 401 may be set to values to indicate the start time and duration, respectively, for the multicast data transmission 407. Alternatively, multicast downlink transmission start time and duration may be indicated by the PSMP frame's 401 own STA Info field 216. The TSID field 223 may be set to 1 or other specific value to indicate that acknowledgement to multicast is requested back from each receiver 106 which has uplink transmission allocated.

According to an example embodiment, in order to provide for reliable multicast data transmissions, uplink transmissions may be scheduled for one or more of the receiver nodes 106 to allow these nodes to transmit acknowledgements to acknowledge receipt of one or more multicast data frames 404, 406 received during multicast data transmission 407, for example. If the TSID field 223 of the multicast STA Info field 216 is set to 1 or other specific value, the receiver node 106 may typically (or should) transmit acknowledgement of one or more multicast data frames 404, 406. Therefore, the ULT fields 231 and 233 in PSMP frame 402 may be set to values indicating start time and duration for a scheduled uplink transmission for each of the one or more receiver nodes 106, 108, to allow these receiver nodes 106, 108 to transmit acknowledgements, for example.

After transmitting the PSMP frame 402, which communicates the transmission schedules for one or more receiver nodes 106, 108, one or more multicast data frames (404, 406, etc.) may be transmitted at 407, e.g., at the scheduled time and up to the scheduled duration described in the PSMP frame 402. Next, one or more receiver nodes 106, 108 may transmit one or more acknowledgements (e.g., ACKs 408, 410) during the time scheduled for their uplink transmission(s) 411. PSMP frame 412 may start the beginning of the next PSMP sequence 401, for example.

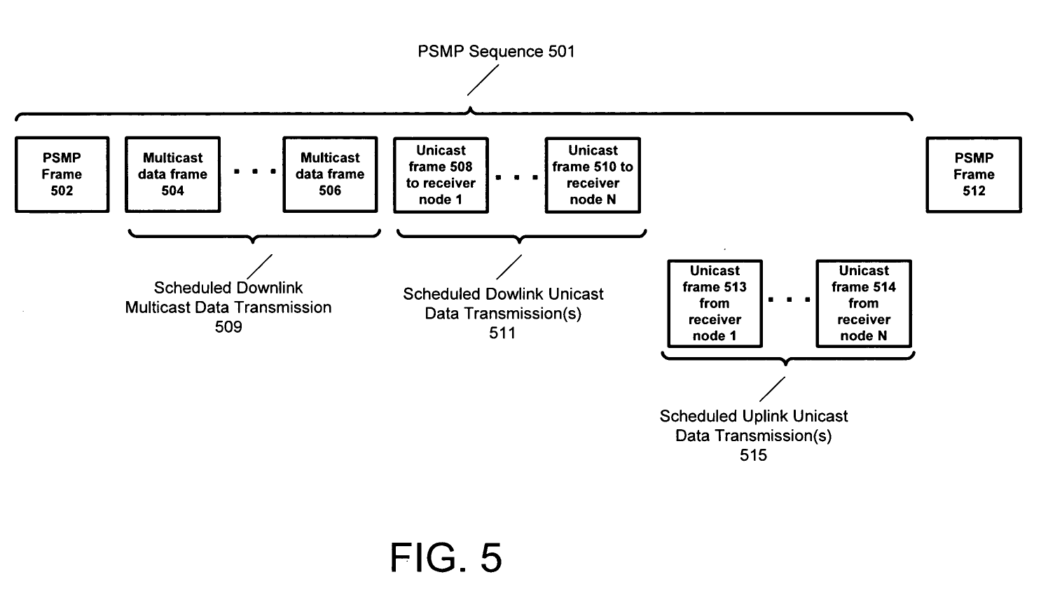

FIG. 5 is a diagram illustrating a PSMP sequence 401 according to yet another example embodiment. In the example embodiment shown in FIG. 5, a PSMP sequence 501 may include the transmission of a PSMP frame 502, followed by a scheduled downlink multicast data transmission 509 to one or more receiver nodes 106, 108, a scheduled downlink unicast data transmission 511 to one or more receiver nodes 106, 108, and a scheduled uplink unicast transmission 515 from one or more receiver nodes 106, 108, for example.

The PSMP frame 502 may include a MAC destination address field 203 set to a multicast group address associated with one or more receiver nodes 106, 108 (e.g., members of the multicast group). In the PSMP frame 502, the TSID field 223 may indicate a traffic stream for which a receiver node 106 may transmit frames during the scheduled uplink unicast data transmission 515, for example. The STA ID field 225 may include the AID for the receiver node 106 (or otherwise identify the receiver node). The DLT fields 227 and 229 may be set to values indicating a start time and duration, respectively, for the scheduled downlink unicast data transmission 511 to the identified receiver node 106. Likewise, the ULT fields 231 and 233 within PSMP frame 502 may be set to values indicating the start time and duration, respectively, for the scheduled uplink unicast data transmission 515 that is being provided to the identified receiver node 106 (e.g., identified by STA ID).

After transmitting the PSMP frame 502, the AP 104 may immediately or substantially immediately (such as without intervening frames) transmit one or more multicast frames (504, 506, . . . ) for the scheduled downlink multicast data transmission 509. In this example embodiment, the DLT fields 227, 229 and other fields of each STA Info field 216 may be used to communicate information related to the other scheduled transmissions 511 and 515. Thus, according to an example embodiment, as a default scheduling time, the downlink multicast data frames 504, 506 may be transmitted immediately after transmission of the PSMP frame 502, for example, so that each receiver node 106 may know or expect the multicast data transmission at this time. Alternatively, a dedicated STA Info field 216 may be used to indicate multicast transmission(s). In this case the TSID field 223 may be set to 1 or other specific value to indicate that the receiver nodes 106, 108 which have scheduled uplink transmissions may send multicast acknowledgement back. The STA ID field 225 may be set to 0. The DLT fields 227 and 229 may be used to communicate downlink multicast transmissions and the ULT fields 231 and 233 may be set to 0 (or don't cares). However, these are merely examples, and the various embodiments are not limited thereto.

Next, one or more unicast frames (e.g., frames 508, 510) may be transmitted to one or more receiver nodes 106, 108 as part of the scheduled downlink unicast data transmission 511. Next, one or more unicast frames (e.g., 513, 514) may be transmitted at 515 by the one or more receiver nodes 106, 108 according to the scheduled times, and may be received at the AP 104. The uplink frames 513, 514 may be acknowledgements (e.g., to the multicast frames), data frames, etc. The PSMP frame 512 may indicate a start of a new PSMP sequence 501, for example.

According to an example embodiment, in a case where an AP 104 schedules both downlink multicast data and unicast downlink data for a station 106 and schedules also uplink (UL) transmission for this station 106 (e.g., for acknowledgements and/or data), the AP 104 may not be able to control how the station 106 is using the scheduled UL transmission (e.g., may not be able to control the station 106 to transmit only acknowledgements during this UL period). In general, a station 106 may be able to transmit acknowledgement to multicast frame or it may send unicast uplink data. According to an example embodiment, if the AP 104 wants to control that the station(s) 106 is really sending the acknowledgement to multicast back during the UL period for the station, it can use TSID for this purpose. Thus, according to an example embodiment, the TSID field 223 in this case may be used by the AP 104 to indicate what the scheduled UL transmission period may be used for (e.g., a first TSID associated with Acks for the multicast transmissions, and a second TSID associated with other UL data frames).

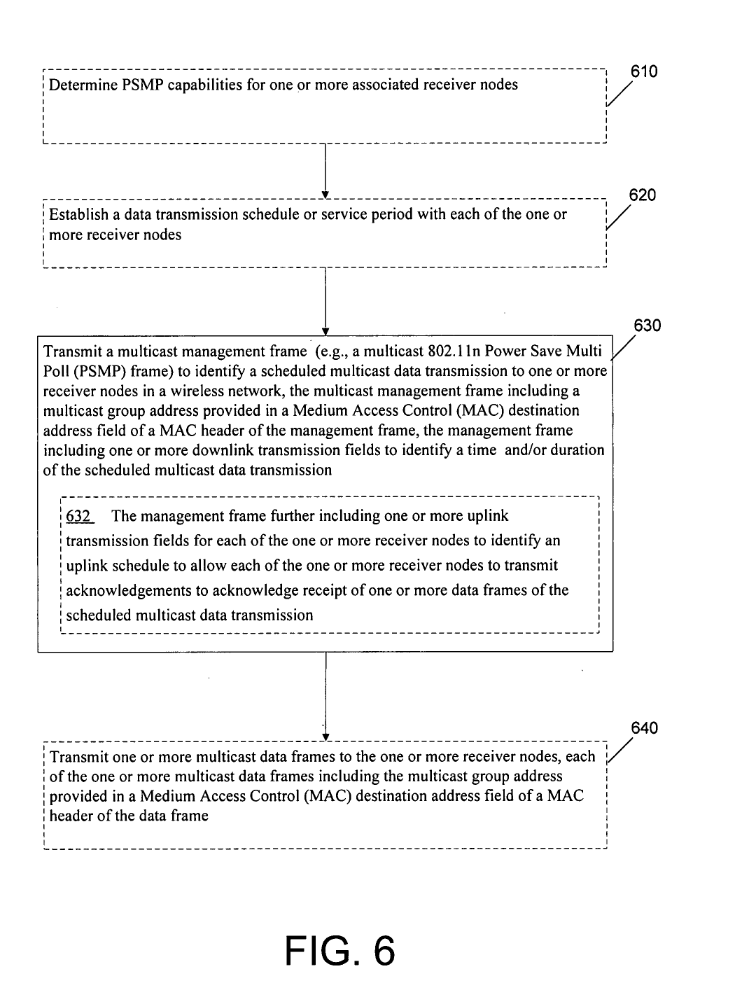

FIG. 6 is a flow chart illustrating operation of a wireless node according to an example embodiment. At 610, the PSMP capabilities may be determined for one or more receiver nodes 106, 108, and an association may be established with one more receiver nodes, 106, 108. At 620, a data transmission schedule or service period may be established with each of the one or more receiver nodes 106, 108, for example.

At 630, a multicast management frame 201 (e.g., a multicast 802.11n Power Save Multi Poll (PSMP) frame) may be transmitted to identify a scheduled multicast data transmission to one or more receiver nodes 106, 108 in a wireless network 102. The multicast management frame 201 may include a multicast group address provided in a MAC destination address field 203 of a MAC header 202 of the management frame 201. The management frame 201 may further include one or more downlink transmission fields to identify a time and/or duration of the scheduled multicast data transmission. In an example embodiment, the management frame 201 may further include one or more uplink transmission fields for each of the one or more receiver nodes 106, 108 to identify an uplink schedule to allow each of the one or more receiver nodes 106, 108 to transmit acknowledgements to acknowledge receipt of one or more multicast data frames 304, 306, 308 of the scheduled multicast data transmission.

At 640, one or more multicast data frames 304, 306, 308 may be transmitted to the one or more receiver nodes 106, 108, each of the one or more multicast data frames 304, 306, 308 including the multicast group address provided in a MAC destination address field 203 of a MAC header 202 of the multicast data frame 304.

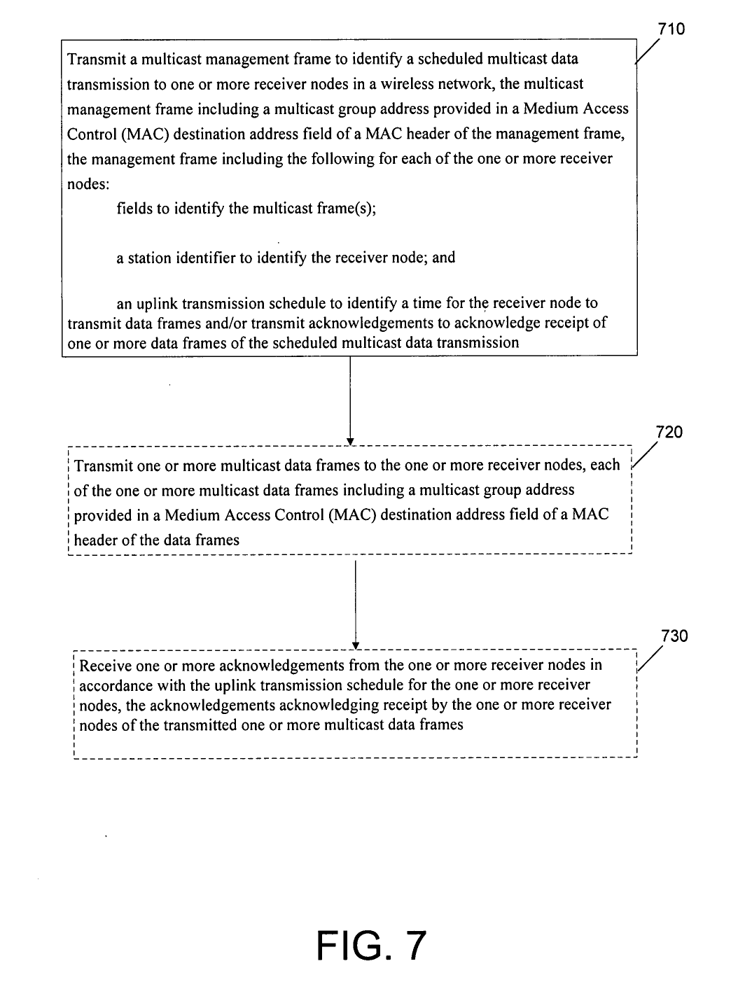

FIG. 7 is a flow chart illustrating operation of a wireless node according to another example embodiment. At 710, a multicast management frame 201 may be transmitted to identify a scheduled multicast data transmission to one or more receiver nodes 106, 108 in a wireless network 102. The multicast management frame 201 may include a multicast group address provided in a MAC destination address field 203 of a MAC header 202 of the management frame 201. The management frame 201 may include the following for each receiver node 106: fields to identify the multicast transmissions, a station identifier to identify the receiver node, and an uplink transmission schedule to identify a time for the receiver node to transmit data frames and/or transmit acknowledgements to acknowledge receipt of one or more data frames of the scheduled multicast data transmission.

At 720, one or more multicast data frames 304, 306, 308 may be transmitted to the one or more receiver nodes 106, 108. Each of the one or more multicast data frames 304, 306, 308 may include a multicast group address provided in a MAC destination address field 203 of a MAC header 202 of the data frames.

At 730, one or more acknowledgements may be received from the one or more receiver nodes 106, 108 in accordance with the uplink transmission schedule for the one or more receiver nodes 106, 108. The acknowledgements may acknowledge receipt by the one or more receiver nodes 106, 108 of the transmitted one or more multicast data frames 304, 306, 308.

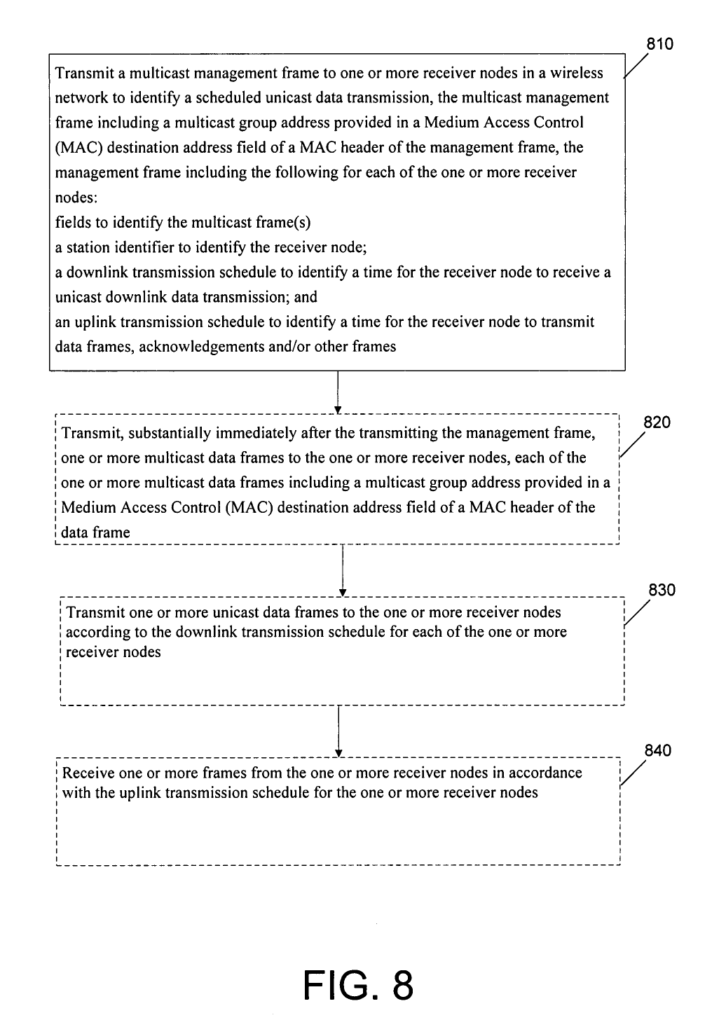

FIG. 8 is a flow chart illustrating operation of a wireless node according to yet another example embodiment. At 810, a multicast management frame 201 may be transmitted to one or more receiver nodes 106, 108 in a wireless network 102 to identify a scheduled unicast data transmission. The multicast management frame 201 may include a multicast group address provided in a MAC destination address field 203 of a MAC header 202 of the management frame 201. The management frame 201 may include the following for each receiver node 106: fields to identify the multicast transmissions; a station identifier to identify the receiver node 106; a downlink transmission schedule to identify a time for the receiver node 106 to receive a unicast downlink data transmission; and an uplink transmission schedule to identify a time for the receiver node 106 to transmit data frames, acknowledgements and/or other frames.

At 820, one or more multicast data frames 304, 306, 308 may be transmitted, substantially immediately (e.g., without transmission of other frames) after the transmitting the management frame 201 to the one or more receiver nodes 106, each of the one or more multicast data frames 304, 306, 308 including a multicast group address provided in a MAC destination address field 203 of a MAC header 202 of the data frame.

At 830, one or more unicast data frames 508, 510 may be transmitted to the one or more receiver nodes 106, 108 according to the downlink transmission schedule for each of the one or more receiver nodes 106, 108.

At 840, one or more frames may be received from the one or more receiver nodes 106, 108 in accordance with the uplink transmission schedule for the one or more receiver nodes 106, 108.

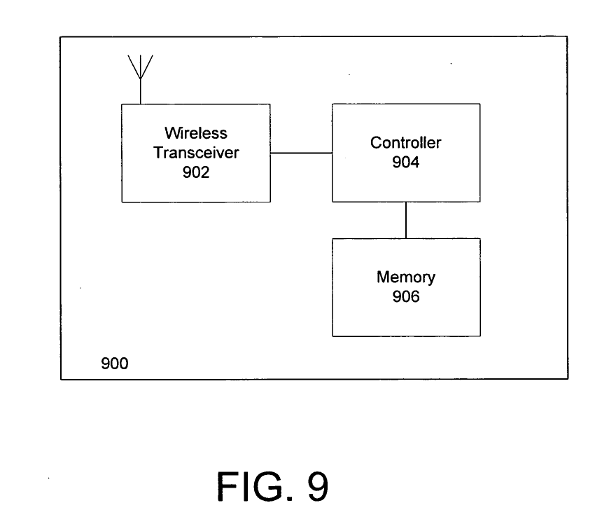

FIG. 9 is a block diagram illustrating an apparatus 900 that may be provided in a wireless node according to an example embodiment. The wireless node (e.g. station 106 or AP 104) may include, for example, a wireless transceiver 902 to transmit and receive signals, a controller 904 to control operation of the station and execute instructions or software, and a memory 906 to store data and/or instructions.

When a wireless node receives a management frame 201 such as in FIG. 2, it may determine whether it is to receive unicast traffic or multicast traffic or both of them based on the schedules determined by the PSMP frame 200. If a determination is made that no traffic is destined to the wireless station, the wireless station may conserve power by entering a low power state.

Controller 904 may be programmable and capable of executing software or other instructions stored in memory or on other computer media to perform the various tasks and functions described above. For example, controller 904 may be programmed to transmit a multicast management frame 201 to identify a scheduled multicast data transmission 309 to one or more receiver nodes 106, 108 in a wireless network 102, the multicast management frame 201 including a multicast group address provided in a MAC destination address field 203 of a MAC header 202 of the management frame 201, the management frame 201 including one or more downlink transmission fields to identify a time and/or duration of the scheduled multicast data transmission.

In another example embodiment, controller 904 may be programmed to transmit a multicast management frame 201 to identify a scheduled multicast data transmission to one or more receiver nodes 106, 108 in a wireless network 102. The multicast management frame 201 may include a multicast group address provided in a MAC destination address field 203 of a MAC header 202 of the management frame 201. The management frame 201 may include one or more of the following, e.g., for each receiver node: a field(s) to identify the multicast transmission(s), a station identifier to identify the receiver node 106, and an uplink transmission schedule to identify a time for the receiver node 106 to transmit data frames and/or transmit acknowledgements to acknowledge receipt of one or more data frames of the scheduled multicast data transmission.

In another example embodiment, controller 904 may be programmed to transmit a multicast management frame 201 to one or more receiver nodes 106, 108 in a wireless network 102 to identify a scheduled unicast data transmission. The multicast management frame 201 may include a multicast group address provided in a MAC destination address field 203 of a MAC header 202 of the management frame 201. The management frame may include one or more of the following, e.g., for one or more of receiver nodes 106, 108: a field(s) to identify the multicast transmissions; a station identifier to identify the receiver node 106; a downlink transmission schedule to identify a time for the receiver node 106 to receive a unicast downlink data transmission; and an uplink transmission schedule to identify a time for the receiver node 106 to transmit data frames, acknowledgements and/or other frames.

In addition, a storage medium may be provided that includes stored instructions which, when executed by a controller or processor, may result in the controller 904, or other controller or processor, performing one or more of the functions or tasks described above.

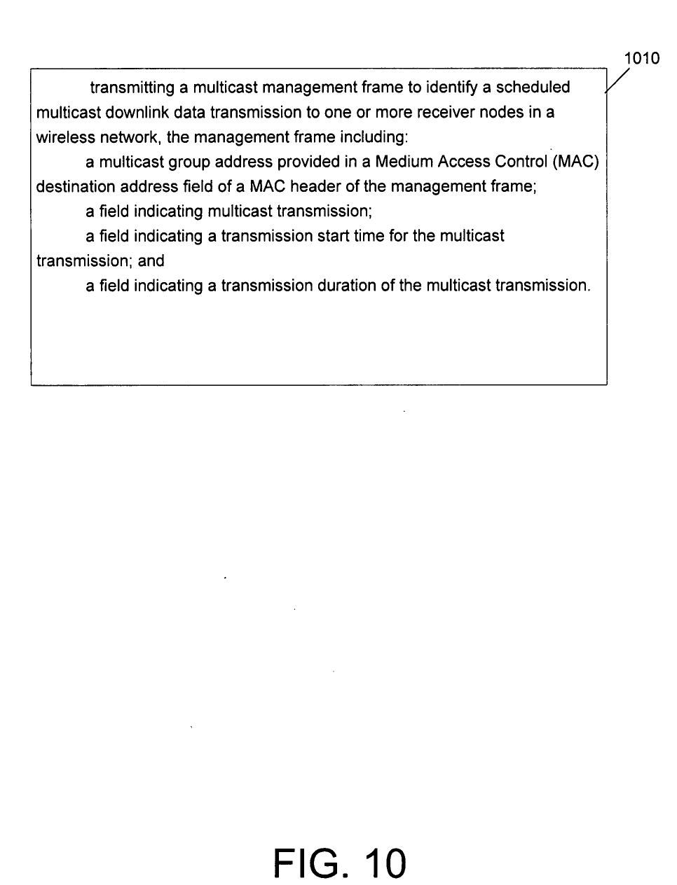

FIG. 10 is a flow chart illustrating operation of a wireless node according to another example embodiment. At 1010, a multicast management frame may be transmitted (e.g., by an AP, Base Station or other node) to identify a scheduled multicast downlink data transmission to one or more receiver nodes in a wireless network. In an example embodiment, the management frame (e.g., PSMP frame) may include: a multicast group address provided in a Medium Access Control (MAC) destination address field of a MAC header of the management frame; a field indicating multicast transmission; a field indicating a transmission start time for the multicast transmission; and a field indicating a transmission duration of the multicast transmission.

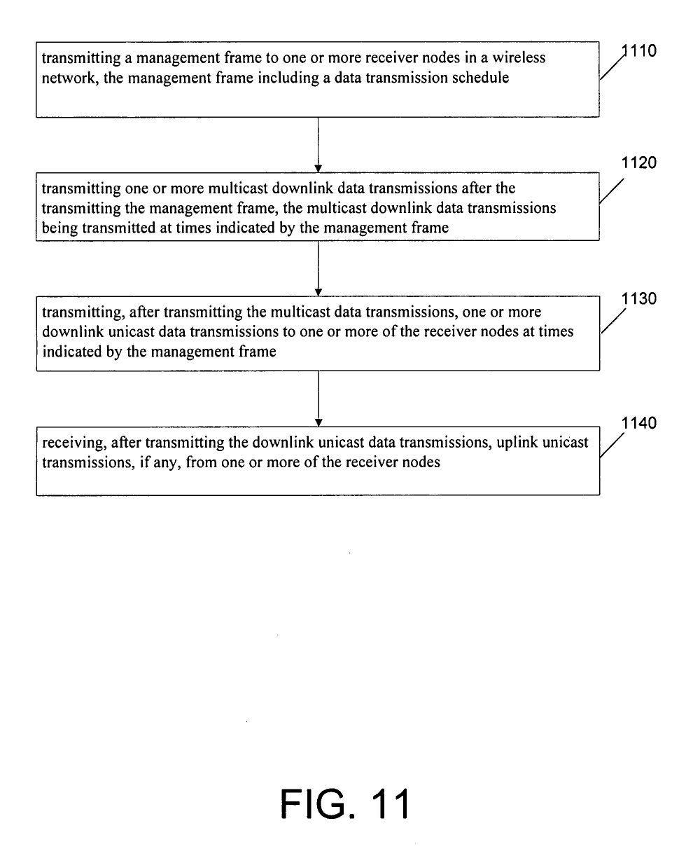

FIG. 11 is a flow chart illustrating operation of a wireless node according to another example embodiment. At 1110, a management frame may be transmitted to one or more receiver nodes in a wireless network. The management frame (e.g., PSMP frame) may include a data transmission schedule.

At 1120, one or more multicast downlink data transmissions may be transmitted after the transmitting the management frame, the multicast downlink data transmissions being transmitted at times indicated by the management frame.

At 1130, after transmitting the multicast data transmissions, one or more downlink unicast data transmissions may be transmitted to one or more of the receiver nodes at times indicated by the management frame.

At 1140, after transmitting the downlink unicast data transmissions, uplink unicast transmissions may be received, if any, from one or more of the receiver nodes.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
transmitting a multicast management frame to identify a scheduled multicast data transmission to one or more receiver nodes in a wireless network, the management frame including a multicast group address provided in a Medium Access Control (MAC) destination address field of a MAC header of the management frame, the management frame including one or more downlink transmission fields to identify a time and/or duration of the scheduled multicast data transmission.

2. The method of claim 1, wherein the transmitting comprises transmitting the management frame, the management frame further including a downlink transmission start offset field indicating a start time for the multicast data transmission and a downlink transmission duration field indicating a duration of the multicast data transmission.

3. The method of claim 1, further comprising transmitting one or more multicast data frames to the one or more receiver nodes, each of the one or more multicast data frames including the multicast group address provided in the Medium Access Control (MAC) destination address field of the MAC header of the data frame.

4. The method of claim 1 and further comprising:
determining power save multi poll capabilities of the one or more receiver nodes;
associating with the one or more receiver nodes;
establishing a data transmission schedule or service period for each of the one or more receiver nodes, the management frame being transmitted to the one or more receiver nodes within the service period.

5. The method of claim 1, wherein the transmitting comprises transmitting the management frame, the management frame further including one or more uplink transmission fields for each of the one or more receiver nodes to identify an uplink schedule to allow each of the one or more receiver nodes to transmit acknowledgements to acknowledge receipt of one or more data frames of the scheduled multicast data transmission.

6. An apparatus provided in a wireless node of a wireless network, the apparatus comprising:
a controller;
a memory coupled to the controller; and
a wireless transceiver coupled to the controller; and
the apparatus being adapted to:
transmit a multicast management frame to identify a scheduled multicast data transmission to one or more receiver nodes in a wireless network, the multicast management frame including a multicast group address provided in a Medium Access Control (MAC) destination address field of a MAC header of the management frame and one or more downlink transmission fields to identify a time and/or duration of the scheduled multicast data transmission.

7. The apparatus of claim 6 wherein the management frame comprises a Power Save Multi Poll (PSMP) frame.

8. The apparatus of claim 6 wherein the management frame comprises an IEEE 802.11n Power Save Multi Poll (PSMP) frame.

9. A method comprising:
transmitting a multicast management frame to identify a scheduled multicast downlink data transmission to one or more receiver nodes in a wireless network, the management frame including:
a multicast group address provided in a Medium Access Control (MAC) destination address field of a MAC header of the management frame;
a field indicating multicast transmission;
a field indicating a transmission start time for the multicast transmission; and
a field indicating a transmission duration of the multicast transmission.

10. The method of claim 9 wherein the transmitting comprises transmitting a multicast management frame, the field indicating a transmission start time for the multicast transmission comprises a DLT start offset field for the multicast transmission.

11. The method of claim 9 wherein the transmitting comprises transmitting a multicast management frame, the field indicating a transmission duration for the multicast transmission comprises a DLT duration field for the multicast transmission.

12. An apparatus adapted for wireless communication, the apparatus comprising:
a controller, the controller being configured to:
transmit a multicast management frame to identify a scheduled multicast downlink data transmission to one or more receiver nodes in a wireless network, the management frame including:
a multicast group address provided in a Medium Access Control (MAC) destination address field of a MAC header of the management frame;
a field indicating multicast transmission;
a field indicating a transmission start time for the multicast transmission; and
a field indicating a transmission duration of the multicast transmission.

13. The apparatus of claim 12 wherein the management frame comprises a Power Save Multi Poll (PSMP) frame.

14. The apparatus of claim 12 wherein the management frame comprises an IEEE 802.11n Power Save Multi Poll (PSMP) frame.

15. The apparatus of claim 12 wherein the field indicating a transmission start time for the multicast transmission comprises a DLT start offset field for the multicast transmission, and the field indicating a transmission duration for the multicast transmission comprises a DLT duration field for the multicast transmission.

16. A method comprising:
transmitting a multicast management frame to identify a scheduled multicast data transmission to one or more receiver nodes in a wireless network, the management frame including a multicast group address provided in a Medium Access Control (MAC) destination address field of a MAC header of the management frame, the management frame including the following for a receiver node:
a field to identify the multicast transmission;
a station identifier to identify the receiver node; and
an uplink transmission schedule to identify a time for the receiver node to transmit data frames and/or transmit acknowledgements to acknowledge receipt of one or more data frames of the scheduled multicast data transmission.

17. The method of claim 16 and further comprising:
transmitting one or more multicast data frames to the one or more receiver nodes, each of the one or more multicast data frames including a multicast group address provided in a Medium Access Control (MAC) destination address field of a MAC header of the data frame; and
receiving one or more acknowledgements from the one or more receiver nodes in accordance with the uplink transmission schedule for the one or more receiver nodes, the acknowledgements acknowledging receipt by the one or more receiver nodes of the transmitted one or more multicast data frames.

18. An article comprising:
a storage medium;
said storage medium including instructions stored thereon that, when executed by a processor, result in:
transmitting a multicast management frame to identify a scheduled multicast downlink data transmission to one or more receiver nodes in a wireless network, the management frame including:
a multicast group address provided in a Medium Access Control (MAC) destination address field of a MAC header of the management frame;
a field indicating multicast transmission;
a field indicating a transmission start time for the multicast transmission; and
a field indicating a transmission duration of the multicast transmission

19. A method comprising:
transmitting a management frame to one or more receiver nodes in a wireless network, the management frame including a data transmission schedule;
transmitting one or more multicast downlink data transmissions after the transmitting the management frame, the multicast downlink data transmissions being transmitted at times indicated by the management frame;
transmitting, after transmitting the multicast data transmissions, one or more downlink unicast data transmissions to one or more of the receiver nodes at times indicated by the management frame; and
receiving, after transmitting the downlink unicast data transmissions, uplink unicast transmissions, if any, from one or more of the receiver nodes.

20. The method of claim 19 wherein the management frame comprises a 802.11 Power Save Multi Poll (PSMP) frame, the transmitting and receiving being part of a PSMP sequence.

21. The method of claim 19 wherein the management frame includes a multicast group address provided in a Medium Access Control (MAC) destination address field of a MAC header of the management frame.
